(19) United States
(12) Patent Application Publication
(10) Pub. No.: US 2016/0309698 A1
(43) Pub. Date: Oct. 27, 2016

(54) RODENT BAIT SYSTEM FOR USE WITH A VEHICLE

(71) Applicant: George John Sykora, Chehalis, WA (US)

(72) Inventor: George John Sykora, Chehalis, WA (US)

(21) Appl. No.: 14/878,927

(22) Filed: Oct. 8, 2015

Related U.S. Application Data
(60) Provisional application No. 62/151,089, filed on Apr. 22, 2015.

(51) Int. Cl. A01M 25/00

(52) U.S. Cl. CPC A01M 25/004

(57) ABSTRACT

A rodent bait system for use with a vehicle to prevent rodents from entering an interior portion of the vehicle is provided. The rodent bait system includes a base assembly having a plurality of tubular members coupled together by connecting joints, the base assembly designed to be disposed on a ground surface and oriented such that the plurality of tubular members and connecting joints conform around at least one tire of the vehicle, the plurality of tubular members having at least one entryway for permitting a rodent to enter the base assembly, a housing assembly coupled to the base assembly, and a bait member disposed within the housing assembly. The rodent enters the entryway of the base assembly and is directed along an interior path defined by any number of the tubular members and connecting joints to permit the rodent to access the bait member.

### RELATED APPLICATION

The application claims priority to provisional patent application U.S. Ser. No. 62/151,089 filed on Apr. 22, 2015, the entire contents of which is herein incorporated by reference.

### BACKGROUND

The embodiments herein relate generally to rodent bait systems.

Vehicles such as cars, trucks, motorcycles and airplanes are often parked outside, sometimes for extended periods of time in long-term storage. This is problematic because rodents residing outdoors often climb into entry points of the vehicle such as the tires and enter the vehicle's interior and/or engine compartment. As a result, these rodents can damage the vehicle by gnawing on electrical wires and/or contaminating interior compartments with feces. There do not exist any rodent bait stations that are designed for use with vehicles stored in an outdoor environment.

As such, there is a need in the industry for a rodent bait system for use with different types of vehicles, which addresses the limitations of the prior art and protects these vehicles from damage. Specifically, there is a need for a rodent bait system that diverts rodents away from common entry points of the vehicle proximate the tires.

### SUMMARY

A rodent bait system for use with a vehicle to prevent rodents from entering an interior portion of the vehicle is provided. The rodent bait system comprises a base assembly comprising a plurality of tubular members coupled together by connecting joints, the base assembly configured to be disposed on a ground surface and oriented such that the plurality of tubular members and connecting joints conform around at least one tire of the vehicle, the plurality of tubular members comprising at least one entryway for permitting a rodent to enter the base assembly, a housing assembly coupled to the base assembly, and a bait member disposed within the housing assembly, wherein the rodent enters the entryway of the base assembly and is directed along an interior path defined by any number of the tubular members and connecting joints to permit the rodent to access the bait member.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the rodent bait system shown in use;

FIG. 2 depicts a perspective view of certain embodiments of the rodent bait system;

FIG. 3 depicts an exploded view of certain embodiments of the rodent bait system;

FIG. 4 depicts a section view of certain embodiments of the rodent bait system taken along line 4-4 in FIG. 2;

FIG. 5 depicts a section view of certain embodiments of the rodent bait system taken along line 5-5 in FIG. 2;

FIG. 6 depicts a perspective view of an alternative embodiment of the rodent bait system;

FIG. 7 depicts an exploded view of an alternative embodiment of the rodent bait system;

FIG. 8 depicts a perspective view of an alternative embodiment of the rodent bait system;

FIG. 9 depicts a perspective view of an alternative embodiment of the rodent bait system;

FIG. 10 depicts a perspective view of an alternative embodiment of the rodent bait system shown in use;

FIG. 11 depicts a perspective view of an alternative embodiment of the rodent bait system;

FIG. 12 depicts a perspective view of an alternative embodiment of the rodent bait system; and

FIG. 13 depicts a section view of certain embodiments of the rodent bait system taken along line 13-13 in FIG. 12.

### DETAILED DESCRIPTION OF CERTAIN EMBODIMENTS

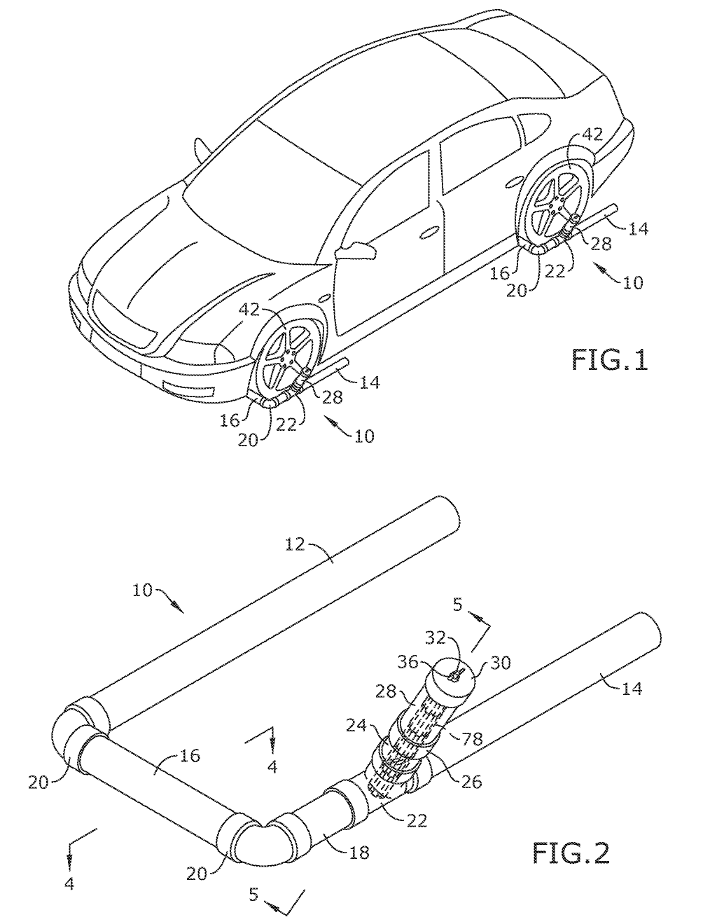

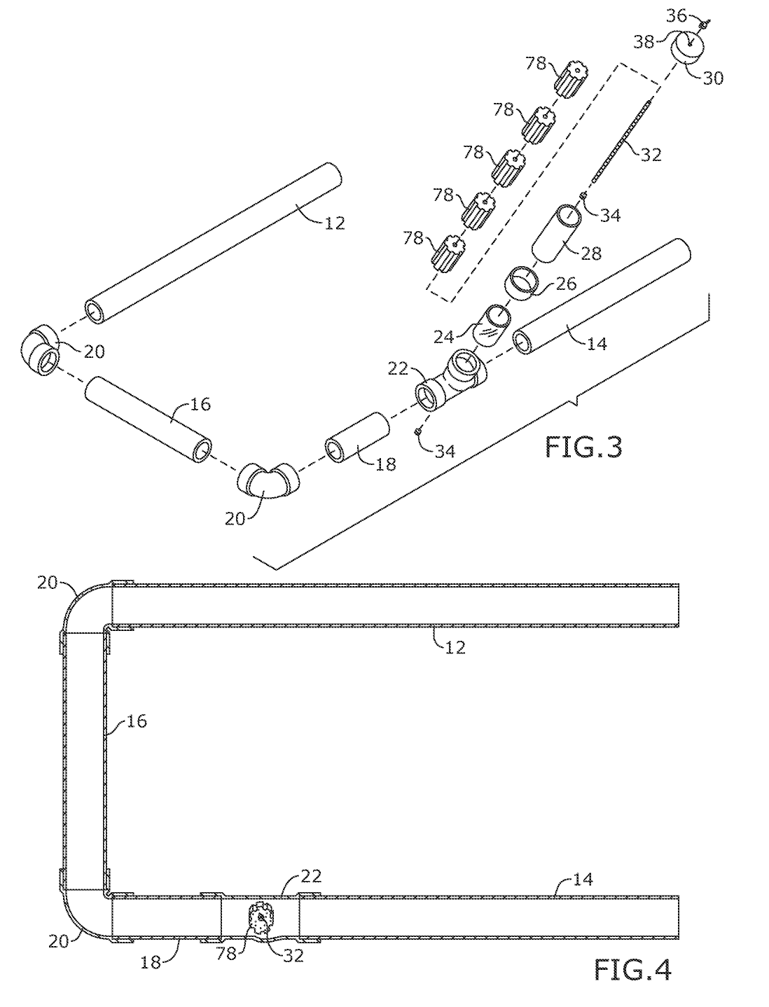

As depicted in FIGS. 1-4, rodent bait system 10 is configured for use with a vehicle to divert a rodent's attention away from common entry points of the vehicle near the tires. This prevents the rodent from entering the vehicle's interior such as an engine compartment and/or other compartment (not shown) and causing damage to the vehicle. Rodent bait system 10 is disposed on the ground and around at least one tire 42 of the vehicle. Although the figures depict rodent bait system 10 for use with a car, it shall be appreciated that the system may be used with any type of vehicle having one or more tires including, but not limited to, other cars, trucks, motorcycles, recreational vehicles, trailers, all-terrain vehicles, snow mobiles, airplanes, or the like, regardless of whether these vehicles have single or multiple axles.

Rodent bait system 10 generally comprises a plurality of tubular members, connecting joints and a housing assembly to store one or more bait blocks 78. As will be apparent in the following disclosure, rodent bait system 10 may have a variety of configurations to accommodate different vehicle types and sizes.

In one exemplary embodiment, the system comprises tubular members and connecting joints coupled together including long entry tube 12, short entry tube 14, end tube 16, corner tube 18, corner elbows 20 and tee coupling 22. Tee coupling 22 is coupled to corner tube 18, short entry tube 14, and a housing assembly. The housing assembly comprises transparent bait tube 24, bait tube coupling 26 and straight bait tube 28 secured together. Specifically, transparent bait tube 24 is coupled to tee coupling 22 and straight bait tube 28 is coupled to transparent bait tube 24 by bait tube coupling 26. In an alternative embodiment, straight bait tube 28 may be transparent.

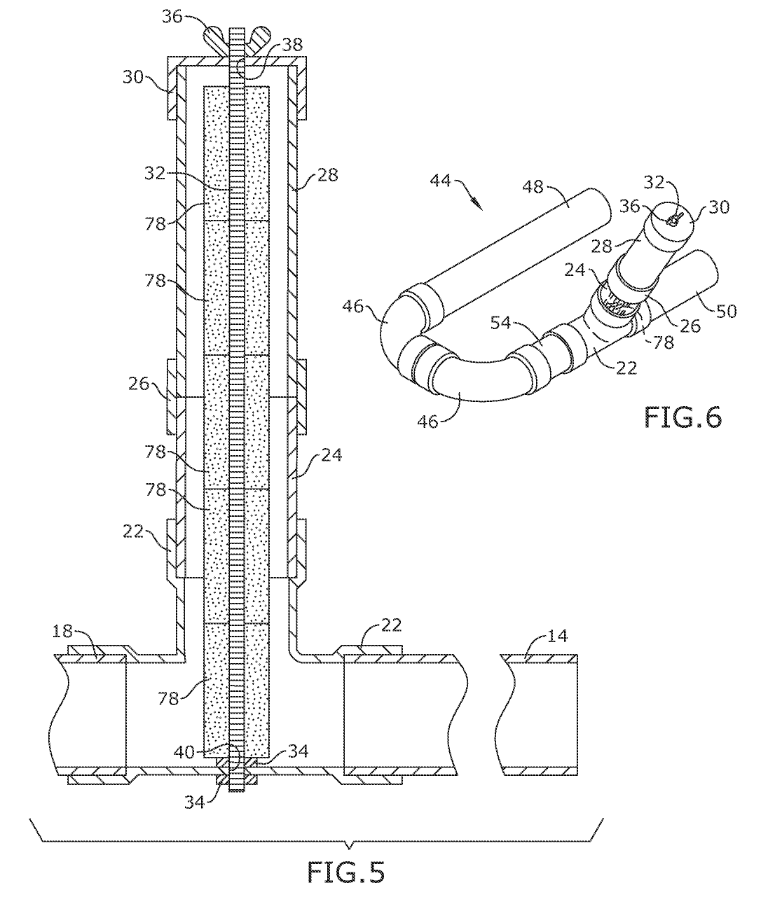

Cap 30 is detachably coupled to the top end of straight bait tube 28. As depicted in FIG. 5, threaded rod 32 is disposed through upper rod hole 38 of cap 30 and lower rod hole 40 of tee coupling 22. Threaded rod 32 is secured to cap 30 by wing nut 36 and tee coupling 22 by a pair of hex nuts 34. Since threaded rod 32 is positioned along the longitudinal axis of the housing assembly, any number of bait blocks 78 can be slidably mounted thereto. Bait blocks 78 may be any type of bait and/or rodenticide known in the field.

In operation, the components of rodent bait system 10 are assembled as described above. Cap 30 is removed from threaded rod 32 and straight bait tube 28 by loosening wing nut 36. Any number of bait blocks 78 are slidably mounted to threaded rod 32 and stored within tee coupling 22, transparent bait tube 24 and/or straight bait tube 28. Cap 30 is secured to threaded rod 32 and straight bait tube 28 via wing nut 36. As depicted in FIG. 1, rodent bait system 10 is disposed on the ground and oriented such that the tubular members and connecting joints conform around any tire 42 of the vehicle. Any number of additional rodent bait systems 10 may be secured to other tires of the vehicle in the same manner. Any rodent (not shown) in proximity of the vehicle is attracted to rodent bait system 10. The rodent enters a passageway, such as the end of long entry tube 12 or short entry tube 14, and is directed along the interior path defined by the tubular members and connecting joints until a bait block 78 positioned within tee coupling 22 is reached. As the rodent consumes bait block 78 within tee coupling 22, the other bait blocks positioned above slide down via gravity to provide easy access of the blocks to the rodent or other rodents.

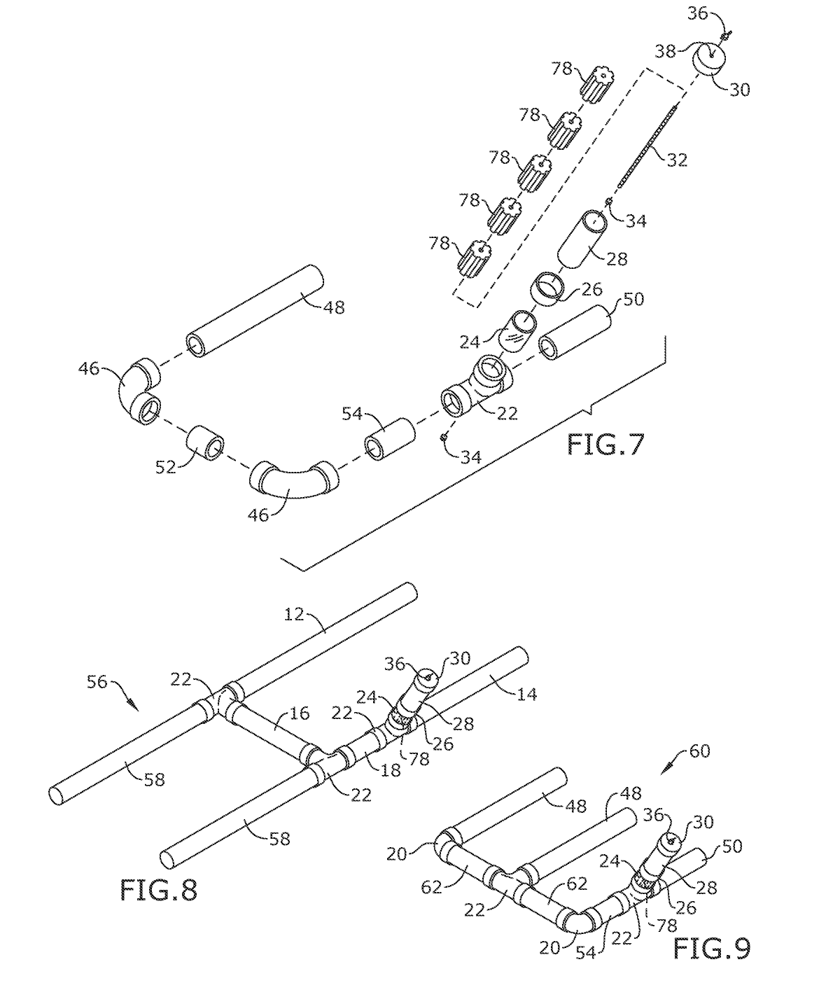

Rodent bait system 10 may have alternative configurations. As depicted in FIGS. 6-7, alternate rodent bait system 44 comprises a plurality of tubular members including alternate long entry tube 48, alternate end tube 52, corner sweep elbows 46, alternate corner tube 54, tee coupling 22 and alternate short entry tube 50. In this configuration, alternate end tube 52 connects adjacent corner sweep elbows 46 together. The housing assembly comprising transparent bait tube 24, bait tube coupling 26, straight bait tube 28 and cap 30 remain the same.

As depicted in FIG. 8, alternate rodent bait system 56 comprises a plurality of tubular members and connecting joints to accommodate multiple tires, which include long entry tube 12, short entry tube 14, corner tube 18, extended entry tubes 58 and tee couplings 22. As depicted in FIG. 9, alternate rodent bait system 60 comprises tubular members and connecting joints such as alternate long entry tubes 48, alternate short entry tube 50, alternate corner tube 54, alternate end tubes 62, corner elbows 20 and tee couplings 22.

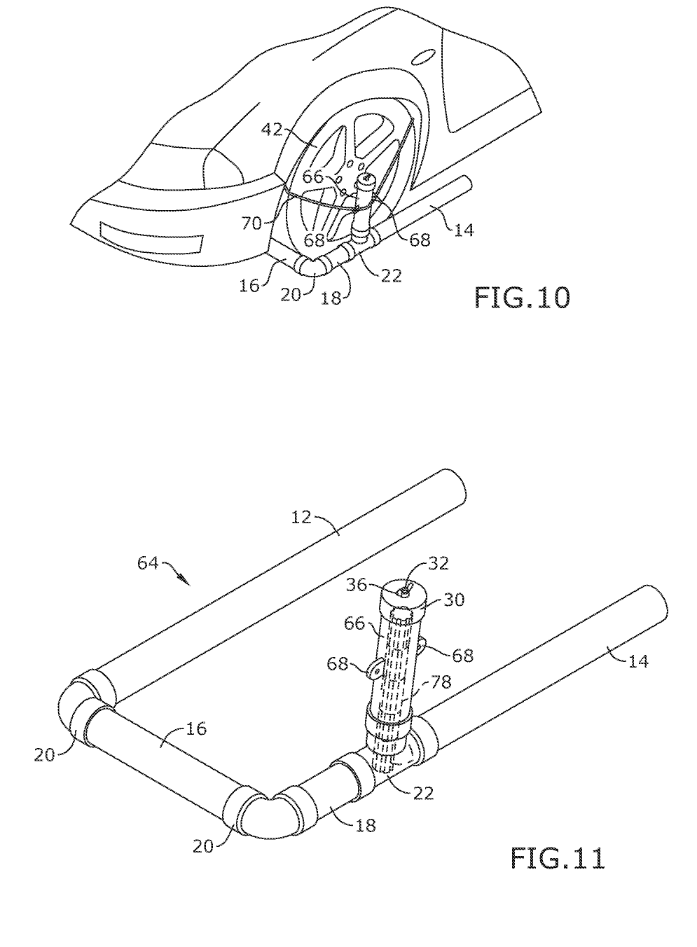

As depicted in FIGS. 10-11, alternate rodent bait system 64 comprises an alternative housing assembly comprising alternate bait tube 66. Alternate bait tube 66 comprises a pair of tabs 68 positioned on opposing outer side portions of the tube. Each tab 68 comprises an aperture. This permits a user to dispose attachment cord 70 through apertures of tabs 68 and around tire 42 of the vehicle. This helps to secure the rodent bait system to the vehicle. It shall be appreciated that tabs 68 may be used on any tubular housing assemblies of any rodent bait system configurations discussed in this application.

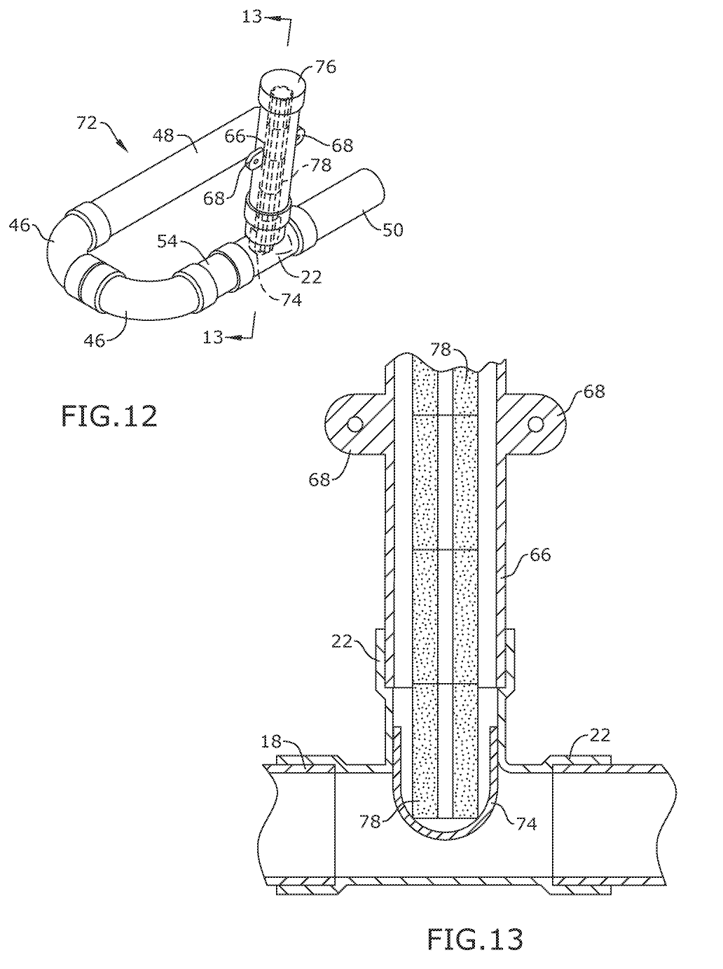

As depicted in FIGS. 12-13, alternate rodent bait system 72 comprises an alternate housing assembly. In particular, the housing assembly comprises alternate bait tube 66 and alternate cap 76. In this configuration, alternate bait tube 66 comprises a first end coupled to tee coupling 22 and a second end detachably coupled to alternate cap 76. As depicted in FIG. 13, curved bait retainer 74 is coupled to an interior wall of tee coupling 22. Curved bait retainer 74 may have variable shapes, but preferably comprises a U-shaped member. Curved bait retainer 74 is preferably molded with tee coupling 22 as a single component. However, curved bait retainer 74 and tee coupling 22 may also be separate components secured together by mechanical fasteners.

To operate alternate rodent bait system 72, alternate cap 76 is removed to permit a user to dispose a plurality of bait blocks 78 within alternate bait tube 66. The stack of bait blocks 78 are supported by curved bait retainer 74. Any rodents present within the rodent bait system have access to the bait blocks supported by curved retainer 74. As bait blocks are consumed, the remaining bait blocks drop down via gravity to curved bait retainer 74. It shall be appreciated that curved bait retainer 74 may be used in conjunction with any of the different rodent bait system configurations herein. This component replaces the need for using threaded rod 32, wing nut 36 and hex nuts 34.

It shall be appreciated that the components of the rodent bait system described in several embodiments herein may comprise any alternative known materials in the field and be of any color, size and/or dimensions. It shall be appreciated that the components of the rodent bait system described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A rodent bait system for use with a vehicle to prevent rodents from entering an interior portion of the vehicle, the rodent bait system comprising:
a base assembly comprising a plurality of tubular members coupled together by connecting joints, the base assembly configured to be disposed on a ground surface and oriented such that the plurality of tubular members and connecting joints conform around at least one tire of the vehicle, the plurality of tubular members comprising at least one entryway for permitting a rodent to enter the base assembly;
a housing assembly coupled to the base assembly; and
a bait member disposed within the housing assembly, wherein the rodent enters the entryway of the base assembly and is directed along an interior path defined by any number of the tubular members and connecting joints to permit the rodent to access the bait member.

2. The rodent bait system of claim 1, wherein the connecting joints comprise elbows and at least one tee coupling.

3. The rodent bait system of claim 2, wherein the housing assembly comprises a plurality of secondary tubular members coupled together, a first end of the secondary tubular members being coupled to a tee coupling of the base assembly and a second end of the secondary tubular members comprising a cap detachably coupled thereto.

4. The rodent bait system of claim 3, further comprising a pair of tabs coupled to one tubular member of the secondary tubular members, each tab comprising an opening configured to receive a cord that is secured around the at least one tire of the vehicle.

5. The rodent bait system of claim 4, wherein at least one of the secondary tubular members is transparent.

6. The rodent bait system of claim 5, further comprising a curved retainer coupled to an interior wall of the tee coupling, wherein the curved retainer is configured to support a plurality of bait members stacked together and positioned along a longitudinal axis of the housing assembly.

7. The rodent bait system of claim 5, further comprising a threaded rod disposed within the housing assembly and comprising a first end detachably coupled to the tee coupling of the base assembly and a second end detachably coupled to the cap, wherein the threaded rod is positioned along a longitudinal axis of the housing assembly.

8. The rodent bait system of claim 7, further comprising a plurality of bait members slidably mounted to the threaded rod.

9. The rodent bait system of claim 8, wherein the first end of the threaded rod is secured to the tee coupling by a pair of hex nuts and the second end of the threaded rod is secured to the cap by a wing nut.
